(19) United States
(12) Patent Application Publication
(10) Pub. No.: US 2021/0052088 A1
(43) Pub. Date: Feb. 25, 2021

(54) SHELF AND LUMINAIRE

(71) Applicant: Hussmann Corporation, Bridgeton, MO (US)

(72) Inventors: Daniel E. Schnur, Saint Peters, MO (US); Raymond P. Twohy, Saint Peters, MO (US)

(21) Appl. No.: 16/963,129

(22) PCT Filed: Jan. 19, 2018
(86) PCT No.: PCT/US2018/014509

§ 371 Date: Jul. 17, 2020

(51) Int. Cl. A47F 3/00; A47F 3/04; A47F 5/00; A47F 11/10; F21V 33/00; F21V 21/32

(52) U.S. Cl. CPC A47F 3/001; A47F 3/0482; A47F 5/0068; F21W 2131/305; F21V 33/00; F21V 21/32; A47F 11/10

(57) ABSTRACT

A shelf assembly including a shelf and a luminaire coupled to a front edge of the shelf. The shelf also includes a rear edge and side edges, as well as a top surface that supports product and a front surface defined at the front edge. The luminaire includes a housing and one or more LEDs that are embedded in the housing and that illuminate above or below the shelf. The front surface of the shelf is non-planar, and the housing is flexible to conform to the non-planar front surface.

### BACKGROUND

The present invention relates to a refrigerated merchandiser, and more particularly, to a refrigerated merchandiser including a shelf and a luminaire that is coupled to the shelf.

Most conventional light assemblies are formed of rigid, inflexible assemblies that must be mounted to flat or planar surfaces (e.g., a bottom or front surface a shelf). Some e light assemblies are secured to the merchandiser using a magnet or a fastener (e.g., screw or bolt). Also, traditional flexible lighting is of non-optical quality and therefore is ineffective at illuminating the surrounding area, especially in multiple directions. More specifically, existing flexible lights only achieve a lumen degradation of 70% of initial output for 15,000-20,000 hours.

### SUMMARY

In one embodiment, the invention provides a shelf assembly including a shelf and a luminaire coupled to a front edge of the shelf. The shelf also includes a rear edge and side edges, as well as a top surface that supports product and a front surface defined at the front edge. The luminaire includes a housing and one or more LEDs that are embedded in the housing and that illuminate above or below the shelf. The front surface of the shelf is non-planar, and the housing is flexible to conform to the non-planar front surface.

In another embodiment the invention provides a luminaire attachable to a surface of a shelf that has a non-planar front surface defined at a front edge of the shelf. The luminaire includes a luminaire support including arms releasably attachable to the front edge of the shelf, and a LED portion including one or more LEDs configured to illuminate above or below the shelf. The luminaire support and the LED portion flex to conform to the non-planar front surface

In another embodiment the invention provides a luminaire including a housing and one or more LEDs that are embedded in the housing. The housing flexes to conform to different-shaped surfaces such that the housing is selectively attachable to a planar surface and a non-planar surface.

Other aspects of the invention will become apparent by consideration of the detailed description and accompanying drawings.

### BRIEF DESCRIPTION OF THE DRAWINGS

FIG. 1 is a perspective view of a merchandiser embodying the invention and including a shelf and a luminaire attached to the shelf.

FIG. 2 is a perspective view of the shelf and the luminaire.

FIG. 3 is a top exploded view of the shelf and luminaire of FIG. 2 illustrating a planar front shelf and the luminaire separated from the shelf.

FIG. 4 is a side view of the shelf and the luminaire of FIG. 3.

FIG. 5 is a section view of the shelf and luminaire of FIG. 4.

FIG. 6 is a top view of the luminaire shown in a first configuration and a second configuration.

FIG. 7 is a top exploded view of the shelf and the luminaire, with the luminaire flexed to the second configuration.

FIG. 8 is a top view of the luminaire attached to the shelf with a curved front surface.

FIG. 9 is a side view of another luminaire embodying the invention.

FIG. 10 is a cross-section of the shelf and the luminaire of FIG. 9.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

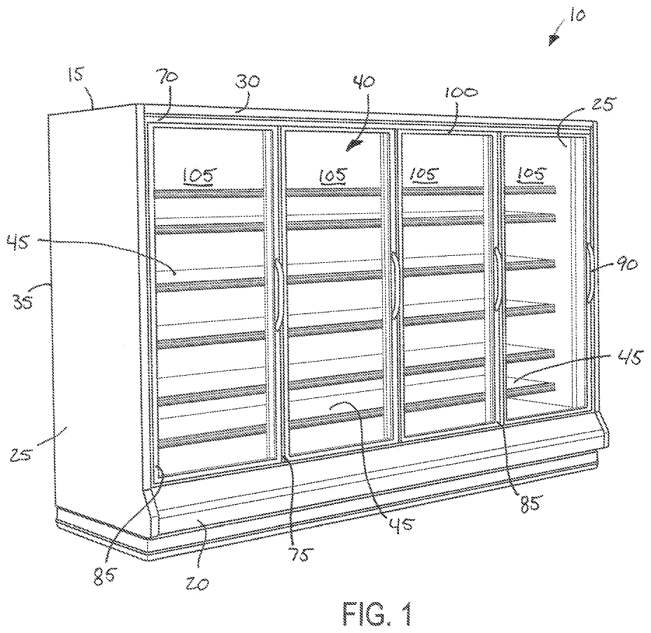

FIG. 1 shows a merchandiser 10 that displays product (e.g., frozen food, fresh food, beverages, non-food product, etc.) available to consumers in a retail setting (e.g., a supermarket or grocery store). The illustrated merchandiser 10 includes a case 15 that has a base 20, side walls 25, a case top or canopy 30, and a rear wall 35, although the merchandiser can be provided in other forms. Also, the merchandiser 10 can be refrigerated or unrefrigerated depending on the product to be displayed. The base 20, the side walls 25, the case top 30, and the rear wall 35 cooperatively define a product display area 40. Shelves 45 are coupled to the rear wall 35 and extend forward to support product within the product display area 40.

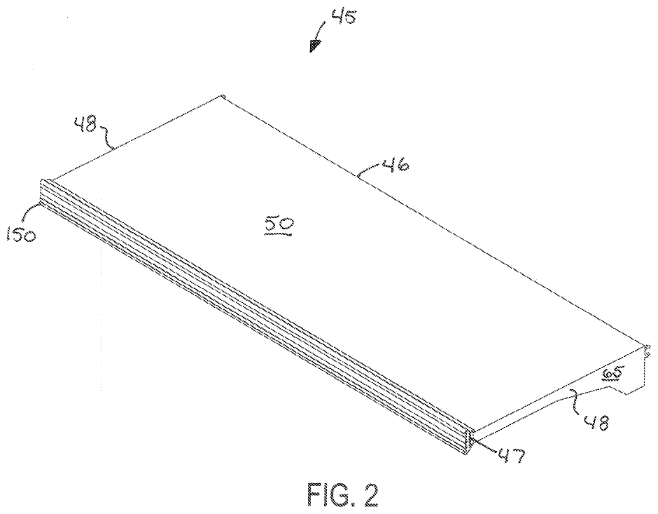

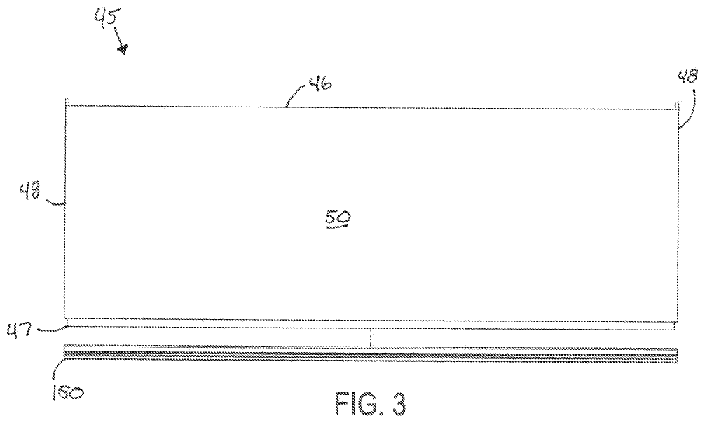

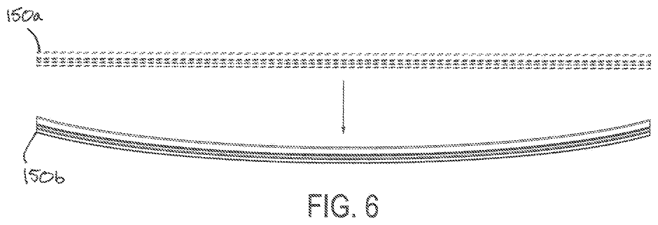

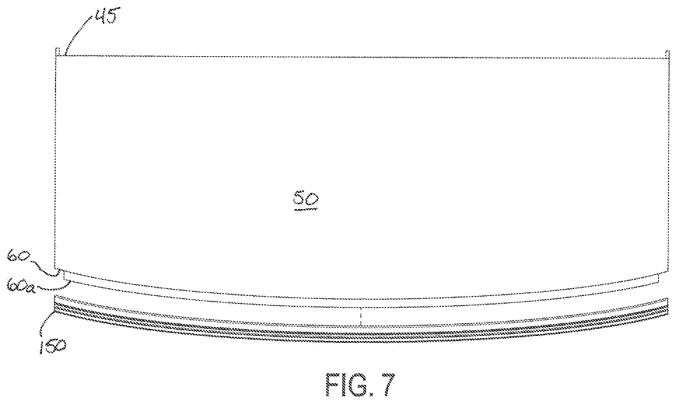

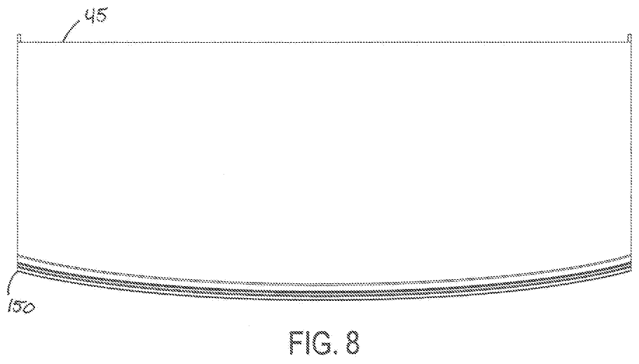

With reference to FIGS. 2-4, each shelf 45 includes a rear edge 46, a front edge 47, and side edges 48 that extend between the rear edge 46 and the front edge 47. The shelf 45 also includes a top surface 50 that supports product, a bottom surface 55 opposite the top surface 50, a front surface 60 defined at the front edge 47, and side surfaces 65 defined by the side edges 48. The front surface 60 and the side surfaces 65 extend between the top and bottom surfaces 50, 55 and between the side surfaces 65. The front surface 60 may have any suitable configuration or shape. For example, the front surface 60 (defined at the edge 47) may be planar, as shown in FIGS. 1-3 and 6, or the front surface 60 may be arcuate or curved, as shown in FIGS. 6-8. In some embodiments, the shelf 45 may have a combination of planar and curved surfaces.

As illustrated, a mounting bracket 67 may be coupled to the shelf 45 adjacent the front surface 60. The mounting bracket 67 may define a secondary front surface 60a of the shelf 45 and be planar or curved (e.g., along a vertical or horizontal axis). Also, the secondary front surface 60a may have the same configuration or a different configuration relative to the front surface 60. That is, the surface 60a may be planar or curved to match the configuration of the front surface 60, or the surface 60a may have a different configuration (e.g., curved when the front surface 60 is planar, or planar when the front surface 60 is curved). For purposes of description, the mounting bracket 67 will be described as part of the shelf 45 and not a separately attached piece such that the surface 60a defines the ‘front surface’ of the shelf 45.

Referring back to FIG. 1, the case 15 includes a frame 70 located adjacent a front of the merchandiser 10. The exemplary frame 70 includes vertical mullions 75 that are spaced horizontally along the case 15 to provide structural support to the case 15 and to define openings to the product display area 40. Each mullion 75 is defined by a structural member that can be formed from a non-metallic material, metallic material, composite material, or any combination of materials suitable to provide structure to the case 15. Doors 85 are coupled to the frame 70 and positioned over the openings 80 to provide selective access to the product display area 40 through the openings. A handle 90 is positioned adjacent an edge of each door 85 to move the door 85 between an open position and a closed position (e.g., via a hinge). Each door 85 includes a frame 100 and a glass member 105 that is secured to each door 80 by the respective door frame 100 to allow viewing of product from outside the case 15. In some constructions, the merchandiser 10 can be provided without doors (e.g., the merchandiser 10 can be an open-front merchandiser).

As will be appreciated, the case top 30, one or more of the shelves 45, and one or more of the mullions 75 (e.g., all or fewer than all of these components), and optionally other parts of the case 15, define case structure that can support one or more luminaires 150. Although the luminaire 150 is described in detail below and shown as being attached to one or more of the shelves 45, it should be appreciated that the luminaire 150 can be attached to other case structure and the specific structure of the components of the luminaire 150 may vary depending the case structure to which the luminaire 150 is attached.

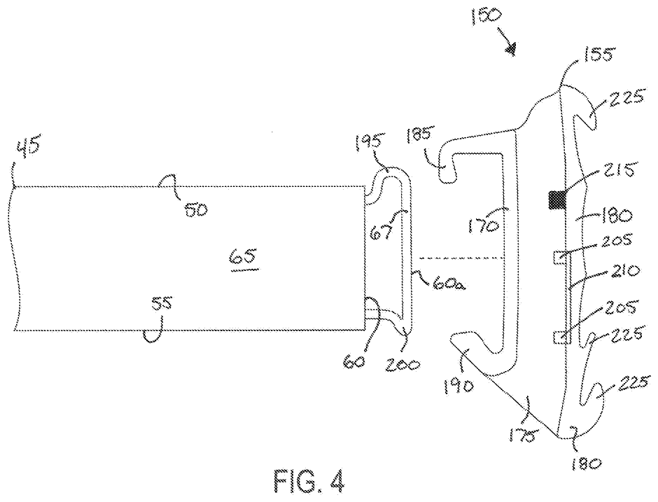

With reference to FIGS. 4, 5, 9, and 10, the luminaire 150 includes an elongated body or housing 155 that defines a first side 160 and a second side 165 that are generally aligned with the sides 65 of the shelf 45, although this is not required (e.g., the luminaire 150 may be shorter than the width of the shelf 45). The elongated body 155 includes a luminaire support 170 and a light emitting diode (“LED”) portion 175 that is coupled to the luminaire support 170. As illustrated, the luminaire 150 can optionally include a price tag support 180 (interchangeably referred to as a price tag molding) that is coupled to the LED portion 15 opposite the luminaire support 170. The illustrated luminaire support 170 extends along a length L of the luminaire 150, although the luminaire support 170 can be divided into smaller sections that are spaced along the length L. The luminaire support 170 defines a flexible attachment for the luminaire 150 to be interchangeably attached to different-shaped edges or surfaces (e.g., a planar surface or a curved surface). As shown in FIG. 4, the luminaire support 170 has attachment arms 185, 190 that secure the luminaire 150 to the front of the shelf 45 (e.g., over corresponding engagement portions 195, 200 of the mounting bracket 67 in a snap fit arrangement).

In general, the luminaire support 170 may be constructed from any material that suitable to be sufficiently flexible (e.g., to bend around a curve having approximately a six inch radius) to conform to different mounting surfaces while being structurally rigid enough to remain attached to the mounting surface. For example, the luminaire support 170 can be formed of a metal (e.g. aluminum), a composite (e.g., carbon fiber), a plastic, other material, or some combination of different materials, that is flexible yet has adequate rigidity to attach the luminaire 150 to the shelf 45 or another structure.

The LED portion 175 is formed of a clear or translucent and flexible or bendable material (e.g., polyvinylchloride with a plasticizer such that the LED portion 175 is inherently flexible due to its material properties) that is optically clear. For example, the LED portion 175 can have a hardness of approximately 50 durometer, although the hardness can be between approximately 40 durometer and 90 durometer.

The LED portion 175 can be attached to and supported by the luminaire support 170 via a co-molding process or using a mechanical fastener (glue, epoxy, screws, etc.) or other suitable attachment mechanism. The LED portion 175 supports (e.g., at least partially encapsulates as shown in FIG. 4) one or more light emitting diodes (“LEDs”) 205 that are mounted on a printed circuit board (PCB) 210, as well as a power source 215 (e.g., via a wired connection, an induction connection, or wireless connection to a remote power supply —not shown). As shown, the LEDs 205 are embedded in the LED portion 175 (i.e. fixed in the material comprising the LED portion 175). The LEDs 205, the PCB 210, and the power source 215 are positioned adjacent a forward longitudinal edge of the LED portion 175 (i.e. opposite the luminaire support 170). In some embodiments, the power source 185 can be a wired connection or a battery that is separately electrically coupled to the luminaire 150. The outward-facing side of the LED portion 175 (i.e. the side supporting the PCB 210) may be solid or contain be substantially or completely opaque to limit the amount of light transmitted forward from the luminaire 150. In some embodiments, the outward-facing side can be substantially clear to allow light to transmit forward (toward the right in FIGS. 4, 5, 9, and 10).

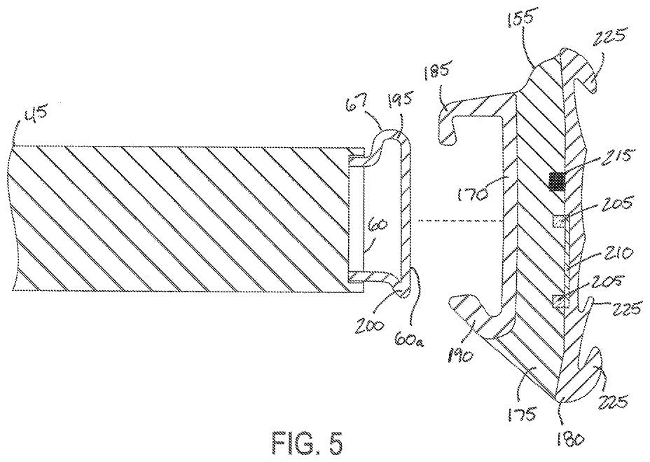

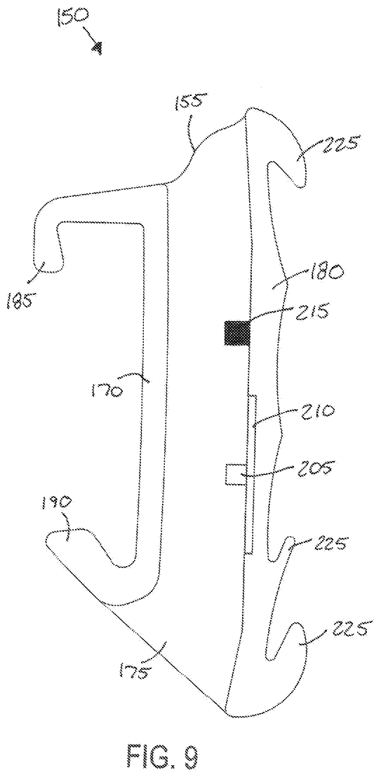

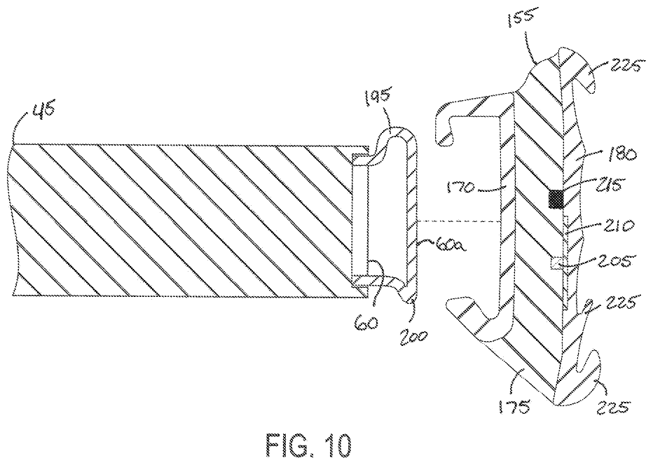

As shown in FIGS. 4 and 5, the LEDs 205 may be a single LED, or one of a plurality of LEDs 205 that are arranged in vertically spaced apart rows along the length L of the luminaire 150. For example, the LEDs 205a in a first row are aligned vertically with the LEDs 205b of a second row. In other embodiments, the LEDs 205a in the first row may be staggered relative to the LEDs 205b of the second row. In some embodiments, the plurality of LEDs 205 may be arranged in any number of rows along the length 190 of the luminaire 150, with LEDs 205 aligned relative to each other, staggered relative to each other, or some combination of alignment and staggering. Also, as shown in FIGS. 9 and 10, the plurality of LEDs 205 can be arranged in a single row along the length L of the luminaire 150. The LEDs 205 may include any suitable intensity or color. For example, the LEDs 205 may be blue LEDs that use remote phosphor technology.

The price tag support 180 can act as a cover or lens for the luminaire 150 that permits transference of light outward from the luminaire 150 or that inhibits or limits transference of light. As shown, the optical portion is formed separately and is coupled to the LED portion 175 (e.g., via fasteners, an adhesive, etc.). In some embodiments, the optical portion 180 can be co-molded with the LED portion 175. The illustrated PCB 210 is sandwiched by the LED portion and the price tag support 180.

The price tag support 180 is constructed from flexible or bendable material (e.g., the same material as the LED portion 175 such that the LED portion 175 is inherently flexible due to its material properties, or any other suitably bendable or flexible arrangement). The price tag support 180 may be translucent to allow backlighting and/or accenting a label that is attached to the price tag support 180. In some embodiments, the price tag support 180 may be constructed integrally with the LED portion 175. The illustrated price tag support 180 has projections 225 that define corresponding pockets or recesses to support a price tag (not shown) with relevant product information (e.g., pricing, barcode information, etc.). In some embodiments, the price tag support 180 can be back-lit by some or all of the LEDs 205. In other embodiments, the luminaire 150 may include a digital display or electronic sales labels (not shown) that is coupled to or part of the price tag support 180. In these latter embodiments, the digital display can utilize light from the LEDs 205, and may include one or more electrical traces that are placed on the front of the price tag support 180 to energize the digital display or electronic sales labels.

The luminaire 150 may further include one or more optical surfaces that are defined by an enhanced surface coating that reduces light transmission loss between the LED portion 175 and the other parts of the luminaire 150. For example, and with reference to FIG. 5, one or both of the luminaire support 170 and the price tag support 180 can include an optical surface at the interface between the luminaire support 170 and the LED portion 175 (e.g., on the outward-facing surface of the luminaire support 170), or at the interface between the LED portion 175 and the price tag support 180 (e.g., on the inward-facing surface of the price tag support 180). In some embodiments, the luminaire can include optical surfaces at any suitable location within the LED portion 175 (e.g., embedded in the LED portion 175), such as at locations adjacent the LEDs 175. Accordingly, the optical surfaces are designed and incorporated to optimize lighting effect in multiple directions relative to the product display area 40.

As shown in FIGS. 2, 3, and 6-8, the luminaire 150 is attached to the front surface 60 of the shelf 45. The luminaire 150 is attachable to a variety of shelves 45 that have different front surface or front edge configurations (planar, curved, or a combination thereof) due to the flexibility or bendability of the luminaire 150. More specifically, the luminaire 150 can be flexed or bent from a first configuration or orientation (i.e. a ‘static’ configuration; see for example FIG. 6) to a second, different configuration or orientation (i.e. a ‘dynamic’ configuration) to match or conform to the configuration of the front of the shelf 45. That is, the luminaire 150 is movable (flexible or bendable) from a first configuration to a second configuration so that the luminaire 150 can be attached to the shelf. The static configuration can be, for example, planar or curved or otherwise non-planar (e.g., a combination of curved and planar), and the dynamic configuration corresponds to the configuration of the front surface 60 of the shelf 45.

As shown in FIGS. 1 and 2, the luminaire 150 has a configuration that attaches to the planar front of the shelf 45 via the luminaire support 170 without being bent or flexed. As shown in FIGS. 6-8, the luminaire 150 starts in a planar configuration 150a and is flexed or bent to a non-planar configuration 150b to attach to the curved front of the shelf 45 via the luminaire support 170. Although not shown, it will be appreciated that the luminaire 150 can start in the curved configuration and be flexed or bent into a planar configuration. Accordingly, the luminaire 150 can achieve any suitable configuration that conforms to the front of the shelf 45.

The luminaire support 170 and the LED portion 175, and the price tag support 180 when provided in the luminaire 150, cooperatively define a housing of the luminaire 150 that supports the LEDs 205 and that is flexible to conform to different-shaped surfaces. Due to the arrangement of LEDs 205 in the clear or translucent LED portion 175, and optionally the optical surfaces, the luminaire 150 directs light above and below the shelf 45 to optimize the light directed toward product on and below the shelf 4 without obstructing access to product by a customer. The luminaire also optimizes heat removal by moving the luminaire 150 from the bottom surface of the shelf 45 to the front surface 60 of the shelf 45, and minimizes the impact of heat on product in the product display area 40. As a result, the luminaire 150 is more efficient and reduces light distortion that plagues existing flexible lights. More specifically, the luminaire 150 achieves a lumen degradation of 85% of initial output for at least 65,000 hours.

Various features and advantages of the invention are set forth in the following claims.

1. A shelf assembly comprising:
a shelf including a rear edge, a front edge, and side edges, the shelf further including a top surface configured to support product and a front surface defined at the front edge; and
a luminaire coupled to the front edge of the shelf, the luminaire including a housing and one or more LEDs embedded in the housing and configured to illuminate above or below the shelf,
wherein the front surface of the shelf is non-planar, and
wherein the housing is flexible to conform to the non-planar front surface.

2. The shelf assembly of claim 1, wherein the one or more LEDs are configured to direct light above and below the shelf.

3. The shelf assembly of claim 1, wherein the housing is defined by one or more flexible materials, and wherein the luminaire includes a power source that is embedded in the flexible material.

4. The shelf assembly of claim 1, wherein the housing includes a luminaire support attached to the front edge of the shelf and an LED portion coupled to the luminaire support, wherein the one or more LEDs are embedded in the LED portion, and wherein each of the luminaire support and the LED portion are configured to flex to conform to the non-planar front surface.

5. The shelf assembly of claim 4, wherein only the LED portion is formed of material that is inherently flexible.

6. The shelf assembly of claim 4, wherein the housing further includes a price tag support coupled to the LED portion, and wherein each of the LED portion and the price tag support is formed of material that is inherently flexible.

7. The shelf assembly of claim 1, wherein the luminaire has a static configuration, and wherein the luminaire is configured to be flexed to a dynamic configuration to match a configuration of the non-planar front surface.

8. The shelf assembly of claim 1, wherein the housing is configured to be flexed about a six inch radius.

9. The shelf assembly of claim 1, wherein the luminaire has a lumen degradation of 85% for at least 65,000 hours.

10. A luminaire attachable to a surface of a shelf having a non-planar front surface defined at a front edge of the shelf, the luminaire comprising:
a luminaire support including arms releasably attachable to the front edge of the shelf; and
a LED portion including one or more LEDs configured to illuminate above or below the shelf,
wherein the luminaire support and the LED portion are configured to be flexed to conform to the non-planar front surface.

11. The luminaire of claim 10, wherein the LED portion is formed of a material that is inherently flexible, and wherein the one or more LEDs are embedded in the LED portion.

12. The luminaire of claim 10, wherein one or both of the luminaire support and the LED portion includes an optical surface.

13. The luminaire of claim 10, further comprising a price tag support coupled to the LED portion.

14. The luminaire of claim 13, wherein each of the LED portion and the price tag support is formed of a material that is inherently flexible.

15. The luminaire of claim 10, wherein the one or more LEDs are configured to direct light above and below the shelf.

16. The luminaire of claim 10, wherein the luminaire includes a power source that is embedded in the LED portion.

17. The luminaire of claim 10, wherein the luminaire support has a static configuration, and wherein the luminaire support is configured to be flexed to a dynamic configuration to match a configuration of the non-planar front surface.

18. A luminaire comprising:
a housing; and
one or more LEDs embedded in the housing,
wherein the housing is configured to flex to conform to different-shaped surfaces such that the housing is selectively attachable to a planar surface and a non-planar surface.

19. The luminaire of claim 18, wherein the housing includes a luminaire support including arms releasably attachable to the planar surface or the non-planar surface, and a LED portion including one or more LEDs.

20. The luminaire of claim 19, wherein one or both of the luminaire support and the LED portion includes an optical surface.

21. The luminaire of claim 19, wherein the LEDs are embedded in the LED portion.

22. The luminaire of claim 18, wherein only a portion of the housing is formed of a material that is inherently flexible.
